(19) United States
(12) Patent Application Publication
(10) Pub. No.: US 2026/0058573 A1
(43) Pub. Date: Feb. 26, 2026

(54) PIEZOELECTRIC ACTUATOR

(71) Applicant: Luxshare Intelligent Manufacture Technology (Changshu) Co., Ltd, Changshu City (CN)

(72) Inventors: Po-Ying TSENG, Changshu City (CN); Chen-Yu CHAO, Changshu City (CN); Sz-Rung LAI, Changshu City (CN)

(73) Assignee: Luxshare Intelligent Manufacture Technology (Changshu) Co., Ltd, Changshu City (CN)

(21) Appl. No.: 18/953,333

(22) Filed: Nov. 20, 2024

(30) Foreign Application Priority Data
Aug. 23, 2024 (CN) 202411162499.6

(51) Int. Cl. H02N 2/10; G02B 7/04

(52) U.S. Cl. CPC H02N 2/103; G02B 7/04

(57) ABSTRACT

A piezoelectric actuator includes a securing end, an actuation end, a piezoelectric assembly, a secondary driven member, a precompression magnet and a decompression assembly. The piezoelectric assembly can drive the secondary driven member to move at the securing end to enable the actuation end to move. The precompression magnet is disposed on the secondary driven member, and configured to interact with the securing end through magnetic forces to enable the secondary driven member to be pressed against the securing end with a preset pressure. The decompression assembly includes a decompression magnet and a decompression coil. The decompression coil is electrified to attract or repel the securing end. Alternatively, the decompression coil can allow a current in the decompression coil to change a direction to have a magnetic field with magnetic properties identical or opposite to magnetic properties of the decompression magnet.

### CROSS-REFERENCE TO RELATED APPLICATION(S)

This application claims priority to Chinese Patent Application No. 202411162499.6 filed Aug. 23, 2024, the disclosure of which is incorporated herein by reference in its entirety.

### TECHNICAL FIELD

The present invention relates to the field of micro-drive technology and, in particular, to a piezoelectric actuator.

### BACKGROUND

As an element that uses a reverse piezoelectric effect to generate a displacement by applying a voltage, a piezoelectric actuator may provide an alternative for familiar electromagnetic devices (such as a motor and a solenoid). The piezoelectric actuator has the advantages of higher reliability, lower power consumption, smaller size and higher position resolution. Since the piezoelectric actuator is driven by a friction force, the piezoelectric actuator has a holding force when not being electrified. However, the holding force is affected by a precompression force of the piezoelectric actuator, the friction surface, the property of a piezoelectric material and the geometric design of the piezoelectric actuator, so the design of the holding force of the piezoelectric actuator is limited.

### SUMMARY

The present invention provides a piezoelectric actuator with good design freedom of the holding force, more stable movement of a secondary driven member and an additional braking function.

A piezoelectric actuator is provided.

The piezoelectric actuator includes a securing end, an actuation end, a piezoelectric assembly and a secondary driven member, where the piezoelectric assembly is configured to drive the secondary driven member to move at the securing end to enable the actuation end to move; a precompression magnet, where the precompression magnet is disposed on the secondary driven member and configured to interact with the securing end through magnetic forces to enable the secondary driven member to be pressed against the securing end with a preset pressure; and a decompression assembly including a decompression magnet and a decompression coil, where the decompression coil is configured to be electrified to have a magnetic field with magnetic properties identical or opposite to the magnetic properties of the decompression magnet to attract or repel the securing end, so as to keep the securing end stationary relative to the actuation end or to enable the securing end to move relative to the actuation end; or the decompression coil is configured to allow a current in the decompression coil to change a direction to have a magnetic field with magnetic properties identical or opposite to magnetic properties of the decompression magnet.

In the present invention, the precompression magnet is disposed on the secondary driven member, and the securing end is configured as a magnetic material to magnetically attract the precompression magnet to enable the secondary driven member to be pressed against the securing end with the preset pressure so that the upper limit of the holding force between a piezoelectric element and the friction surface can be increased when the piezoelectric assembly is not electrified, thereby improving the design freedom of the piezoelectric actuator. Moreover, the secondary driven member can move more stably. In addition, the piezoelectric actuator is further provided with the decompression assembly. The decompression assembly can change the holding force or enable or disenable the brake between the actuation end and the securing end by changing the magnitude or direction of a magnetic force between the decompression coil and the decompression magnet. Optionally, when the magnetic field of the decompression coil is in the same direction as the decompression magnet, an attractive force is present between the decompression magnet and the securing end, which may increase the upper limit of the preset pressure, and when the magnetic field of the decompression coil is in the opposite direction to the decompression magnet, a repulsive force is present between the decompression magnet and the securing end, that is, the brake is disenabled, and the actuation end may move relative to the securing end in this case.

### BRIEF DESCRIPTION OF DRAWINGS

To illustrate the technical solutions in embodiments of the present invention more clearly, the drawings used in the description of the embodiments of the present invention are briefly described below. Apparently, the drawings described below illustrate some of the embodiments of the present invention, and those of ordinary skill in the art may also obtain other drawings based on the content of the embodiments of the present invention and the drawings on the premise that no creative work is done.

FIG. 1 is a view of a piezoelectric actuator according to an embodiment of the present invention.

FIG. 2 is a partial view of an implementation of a piezoelectric actuator according to an embodiment of the present invention.

FIG. 3 is a partial view of another implementation of a piezoelectric actuator according to an embodiment of the present invention.

FIG. 4 is a view of multiple piezoelectric actuators applied to a camera lens according to an embodiment of the present invention.

FIG. 5 is a view of multiple piezoelectric actuators applied to a display module according to an embodiment of the present invention.

FIG. 6 is a view of multiple piezoelectric actuators applied to a lens according to an embodiment of the present invention.

FIG. 7 is a view of a piezoelectric actuator whose secondary driven member is hidden according to an embodiment of the present invention.

FIG. 8 is a view of a piezoelectric actuator whose securing end and decompression magnet are hidden according to an embodiment of the present invention.

FIG. 9 is another view of a piezoelectric actuator whose secondary driven member is hidden according to an embodiment of the present invention.

FIG. 10 is another view of a piezoelectric actuator whose securing end and decompression magnet are hidden according to an embodiment of the present invention.

FIG. 11 is yet another view of a piezoelectric actuator whose securing end is hidden according to an embodiment of the present invention.

FIG. 12 is still another view of a piezoelectric actuator according to an embodiment of the present invention.

FIG. 13 is a partial view of a piezoelectric actuator using a slidable commutator according to an embodiment of the present invention.

### REFERENCE LIST

100 securing end
   110 fitting block
   120 guide rod
   200 actuation end
   300 piezoelectric assembly
   400 secondary driven member
   410 first guide surface
   411 first avoidance groove
   420 first guide groove
   430 second guide groove
   440 installation groove
   450 stop block
   500 precompression magnet
   600 decompression assembly
   610 decompression magnet
   620 decompression coil
   700 commutator
   710 first commutation wheel
   720 second commutation wheel
   730 commutation shaft
   740 commutation block
   800 rail
   810 second guide surface
   811 third guide groove
   812 second avoidance groove
   820 first avoidance notch
   830 guide protrusion
   840 second avoidance notch
   910 optical lens module or display module
   920 camera lens
   930 lens
   940 installation lug

### DETAILED DESCRIPTION

Embodiments of the present invention are described in detail hereinafter. Examples of the embodiments are illustrated in the drawings, where the same or similar reference numerals indicate the same or similar elements or elements having the same or similar functions. The embodiments described hereinafter with reference to the drawings are exemplary. The embodiments are intended to explain the present invention and are not to be construed as limiting the present invention.

In the description of the present invention, it is to be noted that orientations or position relations indicated by terms such as “center”, “upper”, “lower”, “left”, “right”, “vertical”, “horizontal”, “in” and “out” are based on the drawings. These orientations or position relations are intended to facilitate and simplify the description of the present invention and not to indicate or imply that a device or element referred to must have such particular orientations or must be configured or operated in such particular orientations. Thus, these orientations or position relations are not to be construed as limiting the present invention. In addition, terms such as “first” and “second” are used for the purpose of description and are not to be construed as indicating or implying relative importance. Terms “first position” and “second position” are two different positions.

Unless otherwise expressly specified and limited, the terms “installed”, “connected to each other”, “connected” and “secured” are to be construed in a broad sense, for example, as securely connected or detachably connected; mechanically connected or electrically connected; directly connected to each other, indirectly connected to each other via an intermediary, or internally connected between two elements or interactional relationships between two elements. For those of ordinary skill in the art, specific meanings of the preceding terms in the present invention may be understood based on specific situations.

In the present invention, unless otherwise expressly specified and limited, when a first feature is described as being “above” or “below” a second feature, the first feature and the second feature may be in direct contact or be in contact via another feature between the two features. Moreover, when the first feature is described as being “on”, “above” or “over” the second feature, the first feature is right on, above or over the second feature, the first feature is obliquely on, above or over the second feature, or the first feature is simply at a higher level than the second feature. When the first feature is described as being “under”, “below” or “underneath” the second feature, the first feature is right under, below or underneath the second feature, the first feature is obliquely under, below or underneath the second feature, or the first feature is simply at a lower level than the second feature.

Technical solutions of the present invention are further described hereinafter in conjunction with the drawings and the embodiments.

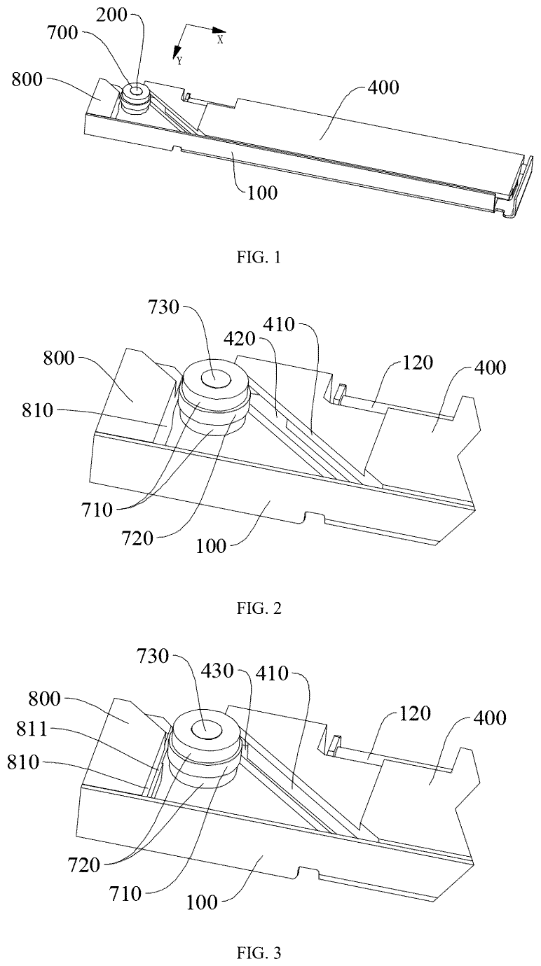

As shown in FIGS. 1 to 7, this embodiment provides a piezoelectric actuator. The piezoelectric actuator includes a securing end 100, an actuation end 200, a piezoelectric assembly 300, a secondary driven member 400, a precompression magnet 500 and a decompression assembly 600. The piezoelectric assembly 300 can drive the secondary driven member 400 to move at the securing end 100 to enable the actuation end 200 to move. The precompression magnet 500 is disposed on the secondary driven member 400 and configured to interact with the securing end 100 through magnetic forces to enable the secondary driven member 400 to be pressed against the securing end 100 with a preset pressure. The decompression assembly 600 includes a decompression magnet 610 and a decompression coil 620. The decompression coil 620 can be electrified to have a magnetic field with magnetic properties identical or opposite to the magnetic properties of the decompression magnet 610 to attract or repel the securing end 100, so as to keep the securing end 100 stationary relative to the actuation end 200 or to enable the securing end 100 to move relative to the actuation end 200. Alternatively, the decompression coil 620 can allow a current in the decompression coil 620 to change a direction to have a magnetic field with magnetic properties identical or opposite to magnetic properties of the decompression magnet 610.

The precompression magnet 500 is disposed on the secondary driven member 400, and the securing end 100 is configured as a magnetic material to magnetically attract the precompression magnet 500 to enable the secondary driven member 400 to be pressed against the securing end 100 with the preset pressure so that the upper limit of the holding force between the piezoelectric element and the friction surface can be increased when the piezoelectric assembly 300 is not electrified, thereby improving the design freedom of the piezoelectric actuator. Moreover, the secondary driven member 400 can move more stably. In addition, the piezoelectric actuator is further provided with the decompression assembly 600. The decompression assembly 600 can change the holding force or enable or disenable the brake between the actuation end 200 and the securing end 100 by changing the magnitude or direction of a magnetic force between the decompression coil 620 and the decompression magnet 610. Optionally, when the magnetic field of the decompression coil 620 is in the same direction as the decompression magnet 610, an attractive force is present between the decompression magnet 610 and the securing end 100, which may increase the upper limit of the preset pressure, and when the magnetic field of the decompression coil 620 is in the opposite direction to the decompression magnet 610, a repulsive force is present between the decompression magnet 610 and the securing end 100, that is, the brake is disenabled, and the actuation end 200 may move relative to the securing end 100 in this case.

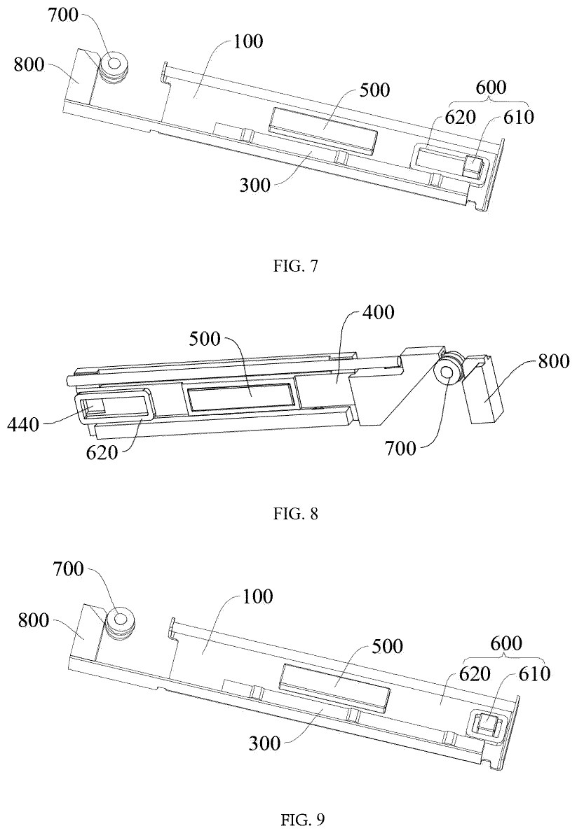

In this embodiment, as shown in FIGS. 7 to 12, to install the decompression assembly 600, the decompression magnet 610 is disposed on the secondary driven member 400 and can move in a direction facing the securing end 100 and in a direction facing away from the securing end 100 so that the decompression magnet 610 can approach and attract the securing end 100 when the decompression coil 620 is electrified and can repel and move away from the securing end 100 when the decompression coil 620 is not electrified.

Optionally, as shown in FIGS. 7 and 8, one side of the secondary driven member 400 facing the securing end 100 is formed with an installation groove 440, and the decompression magnet 610 is slidably disposed within the installation groove 440. It is to be understood that the shape of the installation groove 440 is adapted to the decompression magnet 610 to limit the movement of the decompression magnet 610 along the plane in which the secondary driven member 400 and the securing end 100 move relative to each other. Optionally, the decompression magnet 610 is a cylinder, a cube, or a cuboid. Correspondingly, the cross-section of the installation groove 440 is round, square, or rectangular. It is to be noted that the decompression coil 620 may be wound into different shapes, such as a square, rectangular, or track-shaped cross-section; for one aspect, the decompression coil 620 is configured to be adapted to the shape of the decompression magnet 610, and for another aspect, the decompression coil 620 may be provided with a more desired magnetic force. No specific limitation is made herein.

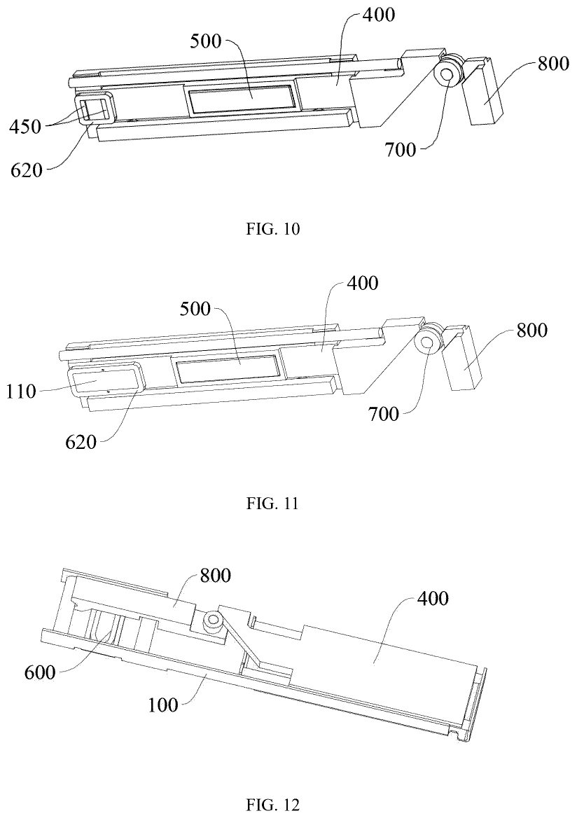

In other embodiments, to simplify the structure of the installation groove 440, as shown in FIGS. 9 and 10, the side of the secondary driven member 400 facing the securing end 100 is provided with two stop blocks 450 that are spaced apart in the movement direction of the secondary driven member 400, where the decompression magnet 610 is disposed within the two stop blocks 450, and the decompression coil 620 is wound outside the two stop blocks 450. The arrangement of the two stop blocks 450 can enable the decompression magnet 610 not to move with the secondary driven member 400 relative to the securing end 100 so that while the installation of the decompression magnet 610 is ensured, the decompression coil 620 can also be wound around the outer sides of the two stop blocks 450, further simplifying the structure of the piezoelectric actuator.

Optionally, as shown in FIG. 11, the securing end 100 may also be provided with a fitting block 110 which faces the decompression magnet 610 and can attract or repel the decompression magnet 610. The fitting block 110 is disposed to replace the fitting between the securing end 100 and the decompression magnet 610. For one aspect, the fitting block 110 may be convenient to replace separately after wear and tear, and for another aspect, the decompression coil 620 may also be wound around the fitting block 110 to simultaneously install the decompression coil 620.

Optionally, the precompression magnet 500 is an electromagnet with an adjustable magnetic force. The magnetic force of the electromagnet has a wider adjustment range, further increasing the upper limit of the holding force between the piezoelectric element and the friction surface when the piezoelectric assembly 300 is not electrified.

As an optional solution for the piezoelectric actuator, as shown in FIG. 12, the decompression magnet 610 is disposed at the actuation end 200 and can move in a direction facing the securing end 100 and in a direction facing away from the securing end 100, and the decompression coil 620 is disposed at the securing end 100. The decompression magnet 610 and the decompression coil 620 act on the actuation end 200 and drive the actuation end 200 to be secured relative to the securing end 100 so as to enable the brake of the piezoelectric actuator.

In other embodiments, as shown in FIGS. 1 to 3, the piezoelectric actuator further includes a commutator 700; the piezoelectric assembly 300 can drive the secondary driven member 400 to move in the first direction relative to the securing end 100; the commutator 700 can drive the actuation end 200 to move in the second direction relative to the securing end 100; and the second direction is disposed at an angle from the first direction. The commutation of the commutator 700 can enable the actuation end 200 to move in the second direction relative to the securing end 100 while enabling the piezoelectric assembly 300 to drive the secondary driven member 400 to move in the first direction relative to the securing end 100, that is, the displacement of the actuation end 200 in the second direction can be converted to the displacement of the secondary driven member 400 in the first direction so that the size of the secondary driven member 400 in the second direction can be reduced, and a movable space is not necessarily reserved in the second direction, thereby effectively reducing the size of the piezoelectric actuator and adding the application scenarios of the piezoelectric actuator.

Further, the securing end 100 of the piezoelectric actuator is further provided with a rail 800. The rail 800 is provided with a second guide surface 810. The secondary driven member 400 is provided with a first guide surface 410. The actuation end 200 is disposed on a commutation shaft 730 of the commutator 700. A first commutation wheel 710 and a second commutation wheel 720 are coaxially sleeved on the commutation shaft 730. The first commutation wheel 710 is configured to fit with the first guide surface 410, and the second commutation wheel 720 is configured to fit with the second guide surface 810. When the secondary driven member 400 moves relative to the securing end 100, the first guide surface 410 drives the first commutation wheel 710 to roll, and since the second guide surface 810 extends in the second direction, the second commutation wheel 720 moves on the rail 800 in the second direction, thereby driving the actuation end 200 to move in the second direction relative to the securing end 100. That is, the first commutation wheel 710 and the second commutation wheel 720 that are coaxially disposed fit with the first guide surface 410 and the second guide surface 810 respectively so that the actuation end 200 and the secondary driven member 400 can move in different directions.

As shown in FIGS. 1 and 2, the commutator 700 includes the commutation shaft 730 and the first commutation wheel 710 and the second commutation wheel 720 that are coaxially sleeved on the commutation shaft 730; the actuation end 200 is disposed on the commutation shaft 730, the first commutation wheel 710 can roll along the first guide surface 410, and the second commutation wheel 720 can roll along the second guide surface 810 to enable the commutator 700 to move in the second direction; and the second direction is disposed at an angle from the first direction.

With the arrangement of the first commutation wheel 710 and the second commutation wheel 720 that are coaxially sleeved on the commutation shaft 730, the first commutation wheel 710 is configured to fit with the first guide surface 410, the second commutation wheel 720 is configured to fit with the second guide surface 810, when the secondary driven member 400 moves relative to the securing end 100, the first guide surface 410 drives the first commutation wheel 710 to roll, and since the second guide surface 810 extends in the second direction, the second commutation wheel 720 moves on the rail 800 in the second direction, thereby driving the actuation end 200 to move in the second direction relative to the securing end 100. That is, the first commutation wheel 710 and the second commutation wheel 720 that are coaxially disposed fit with the first guide surface 410 and the second guide surface 810 respectively so that the actuation end 200 and the secondary driven member 400 can move in different directions.

In this embodiment, the first direction is an X direction shown in FIG. 1, the second direction is a Y direction shown in FIG. 1, and the X direction is vertical to the Y direction.

Further, one end of the secondary driven member 400 facing the commutator 700 is formed with a first guide groove 420, and groove tops of the first guide groove 420 form the first guide surface 410; when the secondary driven member 400 moves, the first commutation wheel 710 fits with the groove tops of the first guide groove 420; and since the diameter of the first commutation wheel 710 is less than the diameter of the second commutation wheel 720, and the groove depth of the first guide groove 420 is greater than the radius difference between the first commutation wheel 710 and the second commutation wheel 720, the second commutation wheel 720 is spaced from the groove bottom of the first guide groove 420. In this manner, no interference is present between the second commutation wheel 720 and the first guide groove 420 so that the fitting between the second commutation wheel 720 and the second guide surface 810 of the rail 800 cannot be affected.

Optionally, two first commutation wheels 710 are provided, and the second commutation wheel 720 is disposed between the two first commutation wheels 710. The two first commutation wheels 710 are in rolling fit with the groove tops on two sides of the first guide groove 420 respectively. The second commutation wheel 720 is disposed within the first guide groove 420 and spaced from the groove bottom of the first guide groove 420. The arrangement of the two first commutation wheels 710 enables a more uniform force applied to the commutator 700 so that the fitting between the commutator 700 and the secondary driven member 400 can be more stable. Moreover, the arrangement of the first guide groove 420 can also effectively prevent the second commutation wheel 720 from escaping from the first guide groove 420 so that the fitting between the commutator 700 and the secondary driven member 400 can be more reliable.

In this embodiment, the first commutation wheel 710 and the second commutation wheel 720 may be sleeved on the commutation shaft 730 through a bearing, or an outer ring of a bearing is used as a first commutation wheel 710 or a second commutation wheel 720. In other embodiments, the axial length of the first commutation wheel 710 may also be greater than the axial length of the second commutation wheel 720, and the second commutation wheel 720 is rotatably disposed on the outer side of the first commutation wheel 710 so that the first commutation wheel 710 can be in rolling fit with the first guide surface 410, and the second commutation wheel 720 can be in rolling fit with the second guide surface 810.

As an optional solution for the piezoelectric actuator, to enable the simultaneous fitting between the commutator 700 and the first guide surface 410 and the second guide surface 810, as shown in FIG. 3, one end of the secondary driven member 400 facing the commutator 700 is formed with a second guide groove 430, the diameter of the first commutation wheel 710 is greater than the diameter of the second commutation wheel 720, the groove bottom of the second guide groove 430 forms the first guide surface 410, and the groove depth of the second guide groove 430 is less than the radius difference between the first commutation wheel 710 and the second commutation wheel 720. With this arrangement, when the secondary driven member 400 moves, the first commutation wheel 710 fits with the groove bottom of the second guide groove 430, and since the groove depth of the second guide groove 430 is less than the radius difference between the first commutation wheel 710 and the second commutation wheel 720, the groove top of the second guide groove 430 does not interfere with the second commutation wheel 720 so that the rolling fit between the second commutation wheel 720 and the second guide surface 810 of the rail 800 cannot be affected.

Further, two second commutation wheels 720 are provided, and the first commutation wheel 710 is disposed between the two second commutation wheels 720. The two second commutation wheels 720 can improve the stability of the fitting between the commutator 700 and the rail 800.

Optionally, the second guide surface 810 is formed with a third guide groove 811 extending in the second direction, and the groove depth of the third guide groove 811 is greater than the radius difference between the first commutation wheel 710 and the second commutation wheel 720 to avoid interference between the groove bottom of the third guide groove 811 and the first commutation wheel 710 and ensure the rolling fit between the second commutation wheel 720 and the second guide surface 810.

Exemplarily, the first guide surface 410 is disposed at an angle of 30° to 60° from the first direction. Optionally, the first guide surface 410 is disposed at an angle of 45° from the first direction. In other embodiments, those skilled in the art may set the angle between the first guide surface 410 and the first direction according to actual application scenarios, and no specific limitation is made here.

Optionally, as shown in FIG. 1, the securing end 100 is provided with a guide rod 120 extending in the first direction, and the secondary driven member 400 can slide along the guide rod 120. The arrangement of the guide rod 120 can limit the movement direction of the secondary driven member 400 relative to the securing end 100.

In this embodiment, to improve the reliability of the guide rod 120 in limiting the secondary driven member 400, the secondary driven member 400 is further formed with a guide groove extending in the first direction, and the guide rod 120 is disposed within the guide groove.

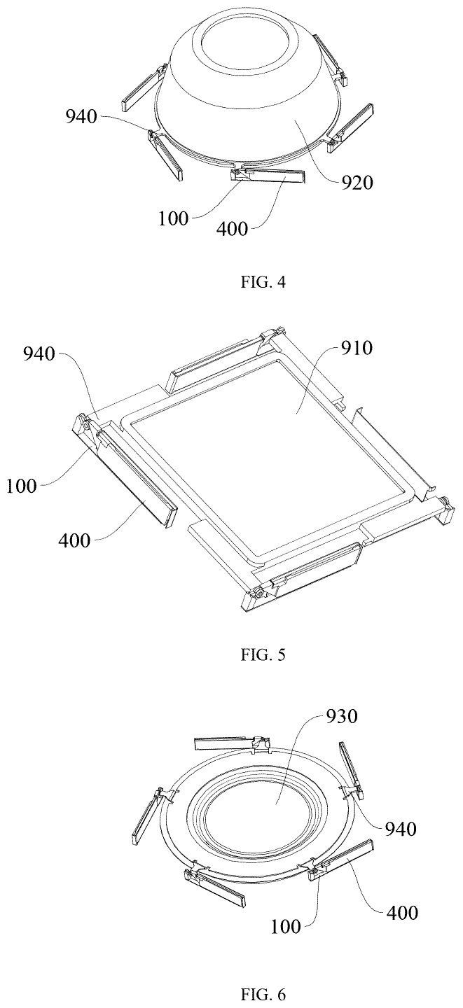

Optionally, as shown in FIGS. 4 to 6, the actuation end 200 is connected to an optical lens module or a display module 910, that is, the piezoelectric actuator may be configured to actuate the optical lens module or the display module 910 in the axial direction of the optical lens module or the display module 910. Optionally, the optical lens module may be a camera lens 920 or a lens 930 so as to change the focal length. Further, the optical lens module or the display module 910 is provided with multiple installation lugs 940 in the circumferential direction of the optical lens module or the display module 910, and actuation ends 200 of multiple piezoelectric actuators are connected to the multiple installation lugs 940 respectively. The arrangement of the multiple piezoelectric actuators can enable the optical lens module or the display module 910 to be driven more stably and reliably.

It is to be noted that the camera lens 920 is provided with six piezoelectric actuators that are evenly spaced apart and flexible in the circumferential direction of the camera lens 920. When two piezoelectric actuators are used as the rotation axis, the camera lens 920 may be rotated by driving the other four piezoelectric actuators to move. It is to be understood that during rotation, piezoelectric actuators located on two sides of the rotation axis move in opposite directions, that is, actuation ends 200 of two piezoelectric actuators located on one side of the rotation axis move upward while actuation ends 200 of two piezoelectric actuators located on the other side of the rotation axis move downward.

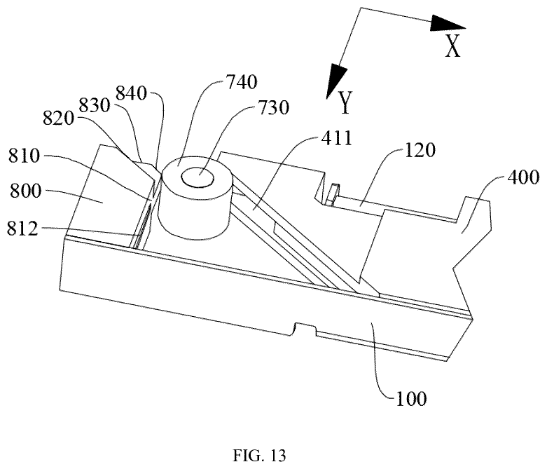

In other embodiments, as shown in FIG. 13, the arrangement of the first commutation wheel 710 and the second commutation wheel 720 that roll may also be eliminated, and the commutator 700 is instead configured to slide with the first guide surface 410 and the second guide surface 810. That is, the commutator 700 simultaneously slides with the first guide surface 410 and the second guide surface 810 so that the actuation end 200 and the secondary driven member 400 can move in different directions.

Optionally, the first guide surface 410 and/or the second guide surface 810 are provided with lubrication layers respectively. The lubrication layers disposed on surfaces of the first guide surface 410 and the second guide surface 810 that are in slidable fit with the commutator 700 can reduce a friction force between the first guide surface 410 and the commutator 700 and a friction force between the second guide surface 810 and the commutator 700 so that a commutation process can be smoother, thereby ensuring a smoother actuation process of the piezoelectric actuator.

As an optional solution for the piezoelectric actuator, one end of the rail 800 is provided with a first avoidance notch 820 so that when the secondary driven member 400 moves facing the rail 800, one end of the secondary driven member 400 facing the rail 800 can be disposed in the first avoidance notch 820, effectively avoiding collision between the secondary driven member 400 and the rail 800.

Optionally, the first guide surface 410 is formed with a first avoidance groove 411 to reduce the contact area between the first guide surface 410 and the commutator 700, thereby reducing the friction force between the commutator 700 and the first guide surface 410.

Further, the first avoidance notch 820 is provided with a guide protrusion 830 that can be disposed within the first avoidance groove 411. The arrangement of the guide protrusion 830 that can fit with the first avoidance groove 411 can not only avoid interference between the rail 800 and the first guide surface 410 but also extend the slide length of the commutator 700 on the second guide surface 810, thereby increasing the actuation distance.

Optionally, the guide protrusion 830 is provided with a second avoidance notch 840. The arrangement of the second avoidance notch 840 can enable the groove bottom of the first avoidance groove 411 to be disposed within the second avoidance notch 840 when the secondary driven member 400 moves facing the rail 800, thereby effectively avoiding collision between the guide protrusion 830 and the first avoidance groove 411.

It is to be noted that in the solution of disposing the first commutation wheel 710 and the second commutation wheel 720, the arrangement of the first avoidance notch 820, the guide protrusion 830 and the second avoidance notch 840 can also avoid the first guide groove 420, reduce interference between the secondary driven member 400 and the rail 800 when the secondary driven member 400 moves and ensure a smoother and more reliable actuation process of the piezoelectric actuator.

In this embodiment, the second guide surface 810 is further formed with a second avoidance groove 812 to reduce the contact area between the second guide surface 810 and the commutator 700, thereby reducing the friction force between the commutator 700 and the second guide surface 810.

As an optional solution for the piezoelectric actuator, the commutator 700 includes the commutation shaft 730 and a commutation block 740 coaxially sleeved on the commutation shaft 730, the actuation end 200 is disposed on the commutation shaft 730, and the commutation block 740 is configured to be slidably connected to the first guide surface 410 and the second guide surface 810. The arrangement of the separated commutator 700 provides convenience for replacing the commutation block 740 after the commutation block 740 is worn, facilitating the prolonging of the service life of the piezoelectric actuator.

Optionally, the commutation block 740 is disposed as a hollow cylinder, the interior of the hollow cylinder is configured to be connected to the commutation shaft 730, and the exterior of the hollow cylinder is configured to be slidably connected to the first guide surface 410 and the second guide surface 810. It is to be understood that the outer wall of the hollow cylinder is in line contact with the first guide surface 410 and the second guide surface 810, which has a smaller friction force than the surface contact, thereby making the movement of the commutator 700 smoother.

Optionally, the outer wall of the commutation block 740 is provided with a lubrication layer. The outer wall of the commutation block 740 that fits with the first guide surface 410 and the second guide surface 810 is provided with the lubrication layer so that the friction force between the commutation block 740 and the first guide surface 410 and the friction force between the commutation block 740 and the second guide surface 810 can be reduced, making the commutation process smoother and thereby ensuring the smoother actuation process of the piezoelectric actuator.

What is claimed is:

1. A piezoelectric actuator, comprising:
a securing end, an actuation end, a piezoelectric assembly and a secondary driven member, wherein the piezoelectric assembly is configured to drive the secondary driven member to move at the securing end to enable the actuation end to move;
a precompression magnet, wherein the precompression magnet is disposed on the secondary driven member and configured to interact with the securing end through magnetic forces to enable the secondary driven member to be pressed against the securing end with a preset pressure; and
a decompression assembly comprising a decompression magnet and a decompression coil, wherein the decompression coil is configured to be electrified to have a magnetic field with magnetic properties identical or opposite to the magnetic properties of the decompression magnet to attract or repel the securing end, so as to keep the securing end stationary relative to the actuation end or to enable the securing end to move relative to the actuation end; or, the decompression coil is configured to allow a current in the decompression coil to change a direction to have a magnetic field with magnetic properties identical or opposite to magnetic properties of the decompression magnet.

2. The piezoelectric actuator of claim 1, wherein the decompression magnet is disposed on the secondary driven member and movable in a direction facing the securing end and in a direction facing away from the securing end.

3. The piezoelectric actuator of claim 2, wherein one side of the secondary driven member facing the securing end is formed with an installation groove, and the decompression magnet is slidably disposed within the installation groove.

4. The piezoelectric actuator of claim 2, wherein one side of the secondary driven member facing the securing end is provided with two stop blocks that are spaced apart in a movement direction of the secondary driven member, wherein the decompression magnet is disposed within the two stop blocks, and the decompression coil is wound outside the two stop blocks.

5. The piezoelectric actuator of claim 2, wherein the securing end is provided with a fitting block facing the decompression magnet and configured to attract or repel the decompression magnet.

6. The piezoelectric actuator of claim 5, wherein the decompression coil is wound around the fitting block.

7. The piezoelectric actuator of claim 1, wherein the decompression magnet is disposed at the actuation end and movable in a direction facing the securing end and in a direction facing away from the securing end, and the decompression coil is disposed at the securing end.

8. The piezoelectric actuator of claim 1, wherein the decompression magnet is a cylinder, a cube, or a cuboid.

9. The piezoelectric actuator of claim 1, wherein the precompression magnet is an electromagnet with an adjustable magnetic force.

10. The piezoelectric actuator of claim 1, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

11. The piezoelectric actuator of claim 2, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

12. The piezoelectric actuator of claim 3, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

13. The piezoelectric actuator of claim 4, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

14. The piezoelectric actuator of claim 5, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

15. The piezoelectric actuator of claim 6, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

16. The piezoelectric actuator of claim 7, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

17. The piezoelectric actuator of claim 8, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.

18. The piezoelectric actuator of claim 9, further comprising a commutator, wherein the piezoelectric assembly is configured to drive the secondary driven member to move in a first direction relative to the securing end, the commutator is configured to drive the actuation end to move in a second direction relative to the securing end, and the second direction is disposed at an angle from the first direction.
